(19) United States
(12) Patent Application Publication
(10) Pub. No.: US 2003/0122673 A1
(43) Pub. Date: Jul. 3, 2003

(54) Tag

(76) Inventor: John Anderson, High Street, Freuchie, Fife (GB)

Correspondence Address: Gregory J Lavorgna, Drinker Biddle & Reath, One Logan Square, 18th and Cherry Streets, Philadelphia, PA, 19103-6996, US

(21) Appl. No.: 10/149,647

(22) PCT Filed: Dec. 15, 2000
(86) PCT No.: PCT/GB00/04808

(30) Foreign Application Priority Data
Dec. 15, 1999 (GB) 9929492.8
Feb. 18, 2000 (GB) 0003848.9
May 13, 2000 (GB) 0011502.2

(51) Int. Cl. G08B 13/14

(52) U.S. Cl. 340/568.7; 340/571; 340/572.1; 340/572.3; 340/5.22

(57) ABSTRACT

There is described an electronic tag system and protection means using the tag system. The tag system has a remotely activated electronic tag and a reader. The system includes means for providing information and data relating to the goods. In addition to the foregoing, which discourages theft there is also provided means for rendering the protected articles useless by staining them with a glue or dye or causing their destruction.

This invention relates to a tag. In particular the invention relates to an electronic tag system and to a means for protection comprising an electronic tag system. Specifically the invention relates to an electronic tag system comprising a remotely activated electronic tag and a reader; to a means for protection of goods comprising a remotely activated electronic tag and a reader; to a dye distribution system; and to a method of electronic protection. The means for protection is adapted to be interrogated to provide information or data relating to the goods; and to discourage or thwart their attempted theft. A specific embodiment of the invention relates to means for rendering articles useless by, for example, staining them with glue or dye, destroying them mechanically or setting them on fire.

Means for electronic surveillance or ‘tagging’ of goods normally comprises a data transaction system such as a radio frequency identification device (RFID), and control apparatus.

Generally, the identification device is adapted to be physically associated with an article, and, in use, the control apparatus is in fixed position, remote from the article. The primary function of such a data transaction system is the transaction of data between identification device and control apparatus. Typically such data is the location information implied by the short range interaction between control apparatus and identification device.

The control apparatus, or ‘reader’, comprises a unit or units that can interrogate, write data to, or read data from the identification device.

In a specific example of such a data transaction system, a reader is installed in the exit from a storage depot for retail merchandise. An identification device or ‘tag’ is placed in association with articles stored in the depot. That is, the articles are ‘tagged’. Ideally, in use, attempted removal of a tagged article should be recognised and indicated by the reader. However, known tag/reader systems have very limited operating performance and capabilities, and are extremely unreliable.

The tag must possess or acquire sufficient energy to participate in a data transaction with the reader.

In some systems, the tag acquires the energy necessary to communicate with its associated reader from a field generated by the reader. Such tags are termed ‘passive’ tags. Acquisition of energy by passive tags is limited either to a range of approximately 1 metre from the reader antenna, or to a narrow cone-shaped field extending from the reader antenna to a maximum range of approximately 5 metres.

Also known are tags as previously described which include an integral energy source, such as a battery. Such tags are termed ‘active’ tags. In an active tag, the life of the battery is dependent on the length of time the tag is active. To conserve battery life, known tags operate on a ‘sleep’/‘wake’ cycle, in which they only ‘wake’ to listen for a relevant signal during a specified interval. A tag does not register a signal transmitted during an interval when it is not awake.

Other drawbacks of known tag/reader systems include their extreme attitude sensitivity—accurate communication between tag and reader depends upon well-defined positional or angular relationships; limited range—tag and reader must be extremely close unless the tag incorporates a power source of significant size and cost; requirement for clear line of sight; and

lack of integral data acquisition and/or data processing capability in the tag.

According to an aspect of the present invention there is provided a tag comprising an electronics unit adapted to detect a signal and to be activated by remote means.

Preferably said electronics unit comprises a power source.

Typically said electronics unit is adapted to acquire data. Said electronics unit may be adapted to process data. Said electronics unit may be programmable. Preferably said electronics unit is adapted to be reprogrammed.

Said electronics unit may comprise signal detection means adapted to operate in response to a command signal from a remote location. Typically said signal detection means comprises a receiver.

Preferably said electronics unit is adapted to modify its behaviour in response to specific criteria, or in response to an external signal.

Preferably said electronics unit comprises means to alter the carrier frequency of a detected signal.

Said means to alter the carrier frequency of a detected signal may comprise an oscillator adapted to provide a signal of frequency substantially different from the carrier frequency.

Preferably said means to alter a detected signal further comprises means to mix the detected signal, and the signal provided by said oscillator.

Preferably said electronics unit comprises signal-decoding means. Said signal decoding means may comprise a microprocessor and an associated memory. More preferably said signal decoding means comprises a microcontroller. Said microcontroller may be adapted to interpret data from a signal of altered carrier frequency.

Typically said microcontroller comprises embedded software adapted to interpret data from a signal of altered carrier frequency.

More preferably said electronics unit comprises a transmitter.

According to a further aspect of the present invention there is provided a tag system comprising a remotely activated electronics unit, and control means.

Typically said electronics unit is adapted to co-operate with said control means.

Preferably said control means comprises a reader.

Said reader may comprise a code generator. Preferably said code generator is adapted to generate a system-specific code.

Said electronics unit and said reader are preferably configured to co-operate at a range of several metres. Said electronics unit and said reader are preferably configured to co-operate over a range of upwards of twelve metres.

Said electronics unit and said reader of said system are preferably configured to co-operate regardless of their relative orientation. Said reader may be adapted to transmit phased signals from at least one antenna. Said electronics unit may be adapted to comprise receiving antennae positioned along more than one axis.

Said electronics unit and said reader of said system are preferably configured to co-operate without line of sight.

Preferably said electronics unit is adapted to be programmed by said reader.

Typically said reader is adapted to alter the performance of said electronics unit. Additionally or alternatively said electronics unit may be adapted to alter its behaviour in response to a given set of circumstances.

According to a further aspect of the present invention there is provided a method of electronic protection or ‘tagging’ comprising the steps of:

placing a tag in physical relationship with an article;

activating or ‘waking’ said tag by means of a signal from a reader at a remote location: and

communicating data to or obtaining data from said tag.

Said method may include the step of encoding data prior to communicating said data to said tag.

Said method may include the step of decoding data in tag.

Said method may include the step of decoding data in said reader.

Said method may include the step of adjusting the behaviour of the tag. Preferably said method includes the initiation of tag behaviour adjustment by the tag itself. Additionally or alternatively said method may include the initiation of tag behaviour adjustment by the reader.

According to a further aspect of the present invention there is provided means for rendering articles useless.

Preferably said means comprises a container adapted to contain banknotes

Said means may comprise a dye distribution apparatus.

Said means may comprise a remotely activated tag, and at least one control transmitter.

Said control transmitters may be write/read units.

Preferably said tag is programmable to permit authorised access to the cassette. Said tag is more preferably adapted to delay authorised access to the container.

Typically said tag is programmable to initiate means to devalue any contents of the container in the event of unauthorised access thereto.

In a preferred embodiment said tag is programmable to provide feedback on status and functionality of said protection means.

Preferably said tag comprises a receiver adapted to read and accept direct commands from a control transmitter.

Typically said control transmitters are adapted to be situated in or in association with existing alarm and/or building management systems.

Preferably said tag is programmable to respond to said control transmitters.

The tag may be capable of autonomously initiating said dye distribution apparatus. The tag may be conditioned to initiate the dye distribution apparatus on registering the presence or absence of a given signal from a variety of sources.

Typically said tag is conditioned to trigger the dye distribution apparatus when an attempt is made to breach the container.

Preferably said tag is conditioned to trigger the dye distribution apparatus when it recognises that it is not in an “area of safety” or within preprogrammed conditions for transit between ‘areas of safety’ as defined by the control transmitters.

Preferably the tag comprises a movement detector. Preferably the tag is conditioned to trigger the dye distribution system when, under specific conditions, the movement detector registers movement.

Preferably said tag is adapted to transmit feedback on its own functionality and status or audit trail information to a reader.

Typically said tag is adapted to control access to the container, obviating the need for a mechanical lock.

Alternatively said tag is adapted to control a mechanical lock.

Further according to the present invention there is provided a liquid dye distribution system.

Preferably the dye distribution system comprises a trough or troughs. The dye distribution apparatus may comprise a spray bar. Preferably the troughs are configured to distribute dye delivered under pressure from the spray bar.

The trough or troughs may comprise a single sheet of material associated with one or more spray bars.

A trough may be associated with a specific spray bar. The trough may be sectioned. The trough may be hinged.

Preferably the system comprises a reservoir for dye. The reservoir may be rigid. The reservoir may be adapted for expulsion of its contents. Preferably the reservoir comprises a piston.

Alternatively the reservoir may be a compliant vessel. Preferably the compliant vessel is situated within a rigid container. Preferably the rigid container is adapted to be pressurised on operation of the system is operated. Preferably pressurisation of the rigid container initiates expulsion of the contents from the compliant vessel.

In a further alternative the dye reservoir may be a rigid container, which also houses a compliant vessel in collapsed state. Preferably pressurisation of the compliant vessel initiates expulsion of contents from the rigid container.

According to a further aspect of the present invention there is provided a means for protection of goods comprising a liquid dye distribution system.

According to a further aspect of the present invention there is provided means for protection adapted for use in a cash dispenser or automatic teller machine (ATM).

Preferably said means for protection may be retrofit to an existing ATM cassette.

Preferably said means for protection does not compromise the banknote storage capacity of the cassette.

Embodiments of the present invention will now be described by way of example only, with reference to the accompanying drawings, in which:

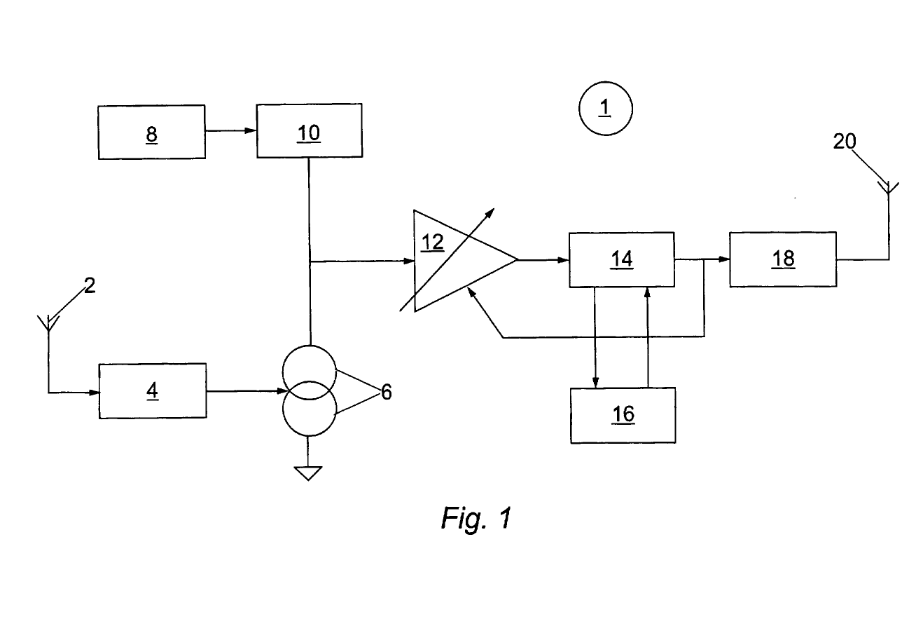

FIG. 1 is a schematic diagram of an electronics unit of a tag according to an aspect of the present invention;

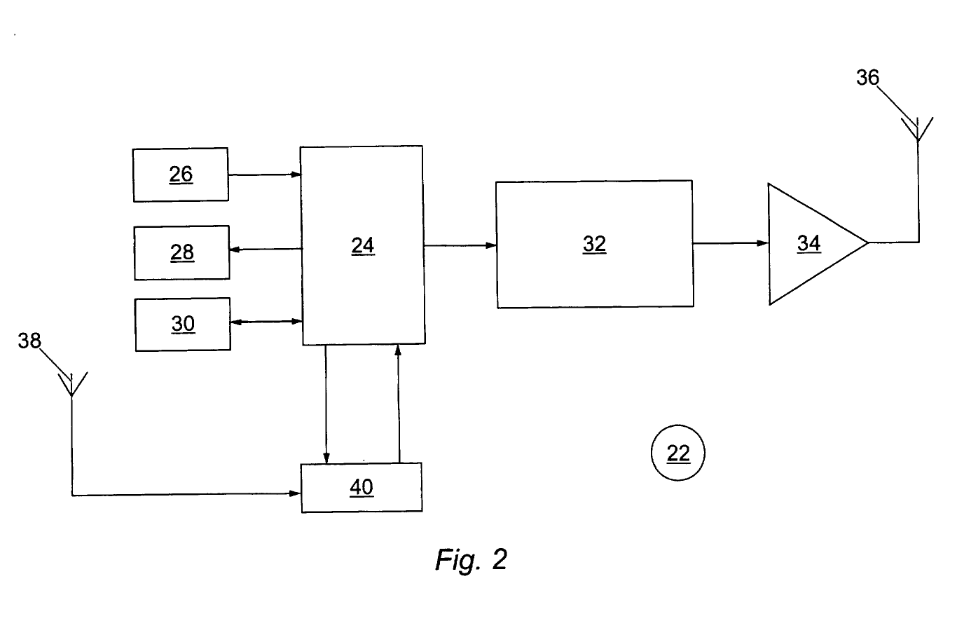

FIG. 2 is a schematic diagram of a reader according to an aspect of the present invention;

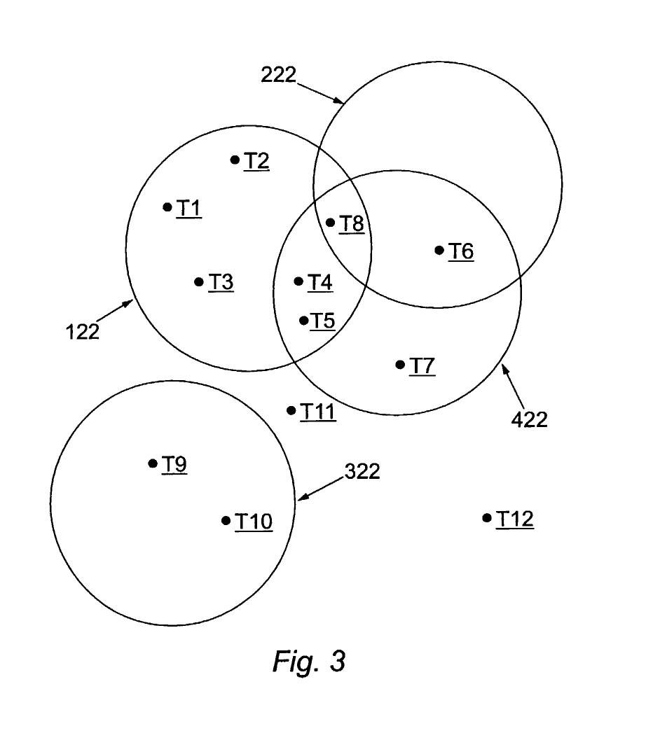

FIG. 3 illustrates the effect of the transmitting capability of a number of readers on a number of tags.

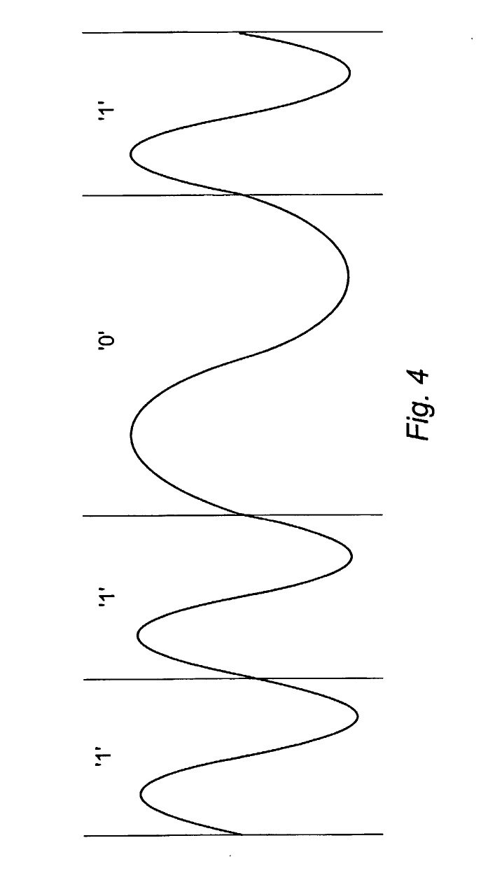

FIG. 4 illustrates a decoded signal;

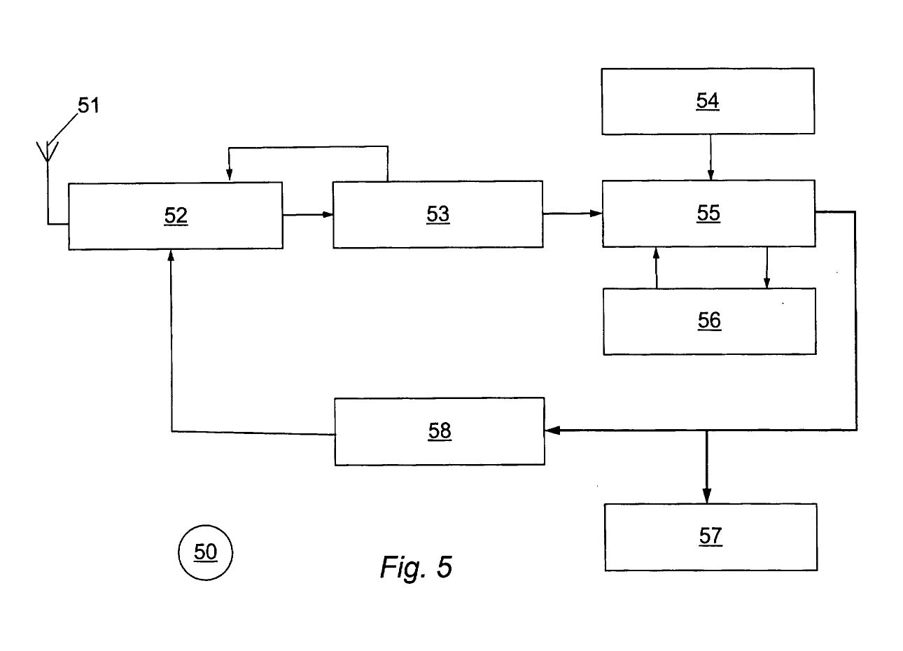

FIG. 5 is a schematic diagram of the tag of FIG. 1 configured as an in-cassette electronics unit (ICE) for an ATM protection system;

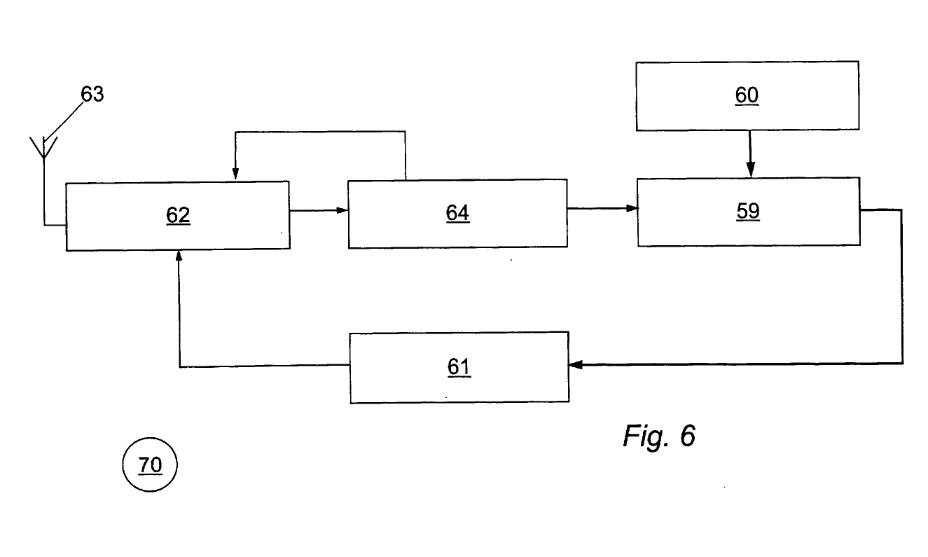

FIG. 6 is a schematic diagram of the reader of FIG. 2 configured as reader for an ATM protection system;

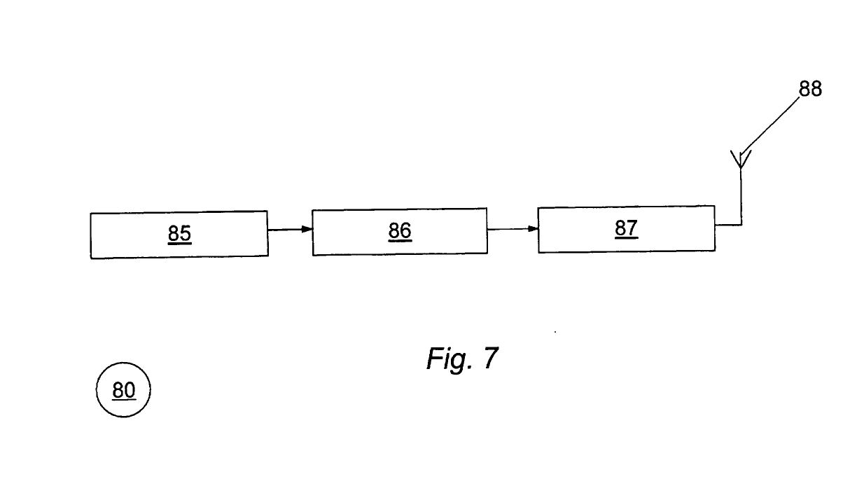

FIG. 7 is a schematic diagram for a reader configured for write only function;

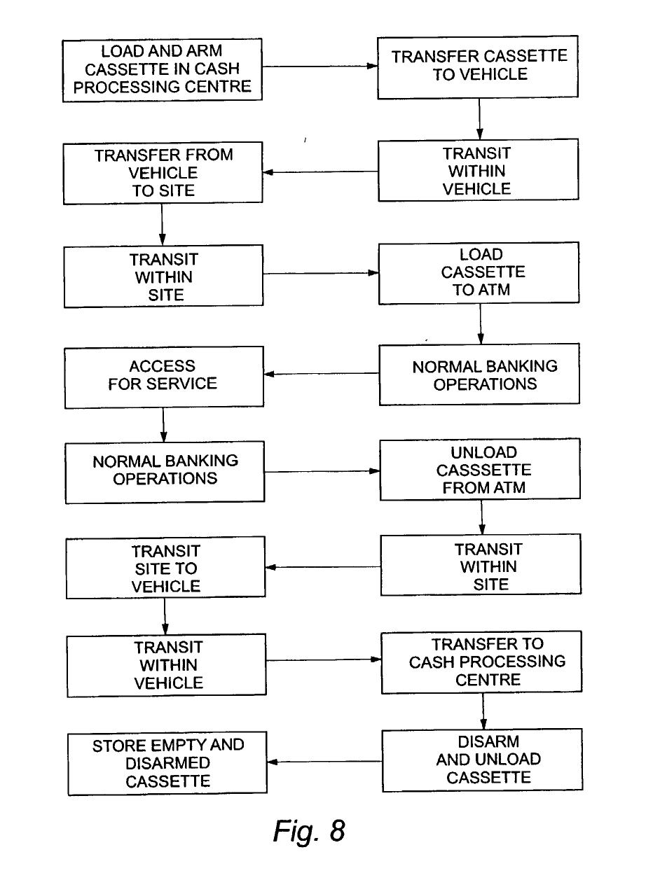

FIG. 8 is a flow diagram of a typical cycle of cash flow to and from an ATM machine;

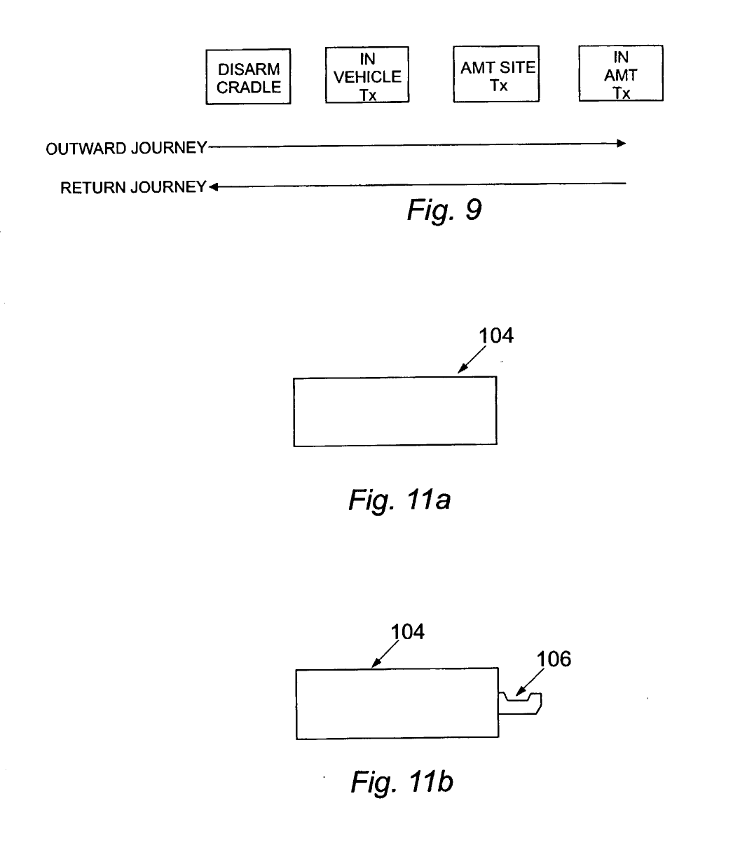

FIG. 9 shows examples of possible external installations (readers) adaptable to send signals to an ICE unit according to the present invention;

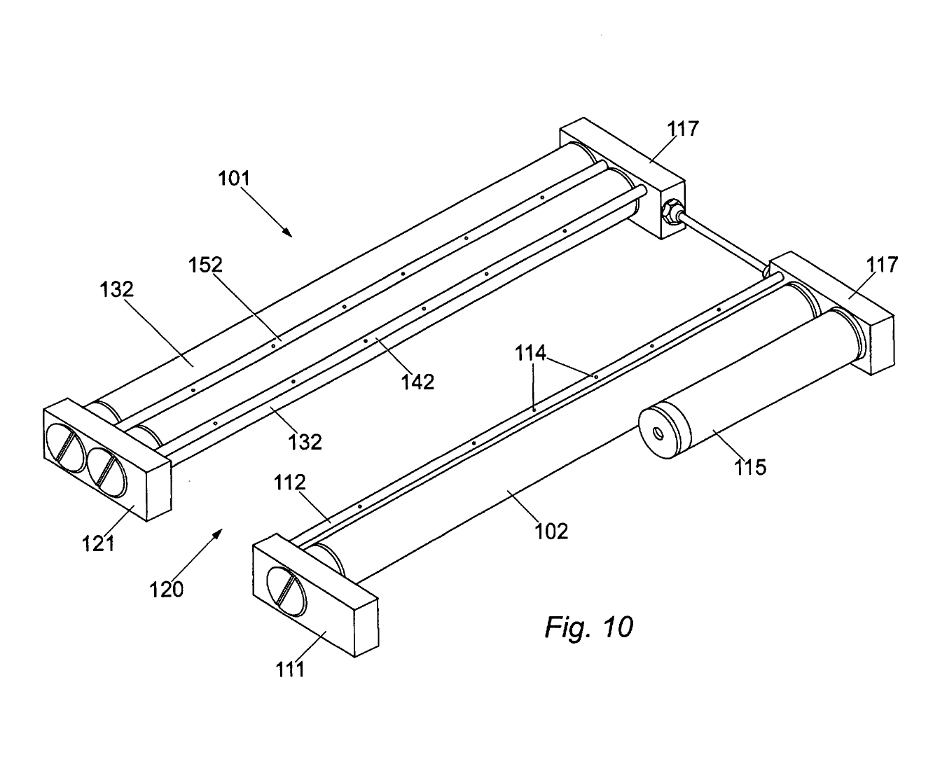

FIG. 10 is a perspective view of a dye distribution system of the present invention;

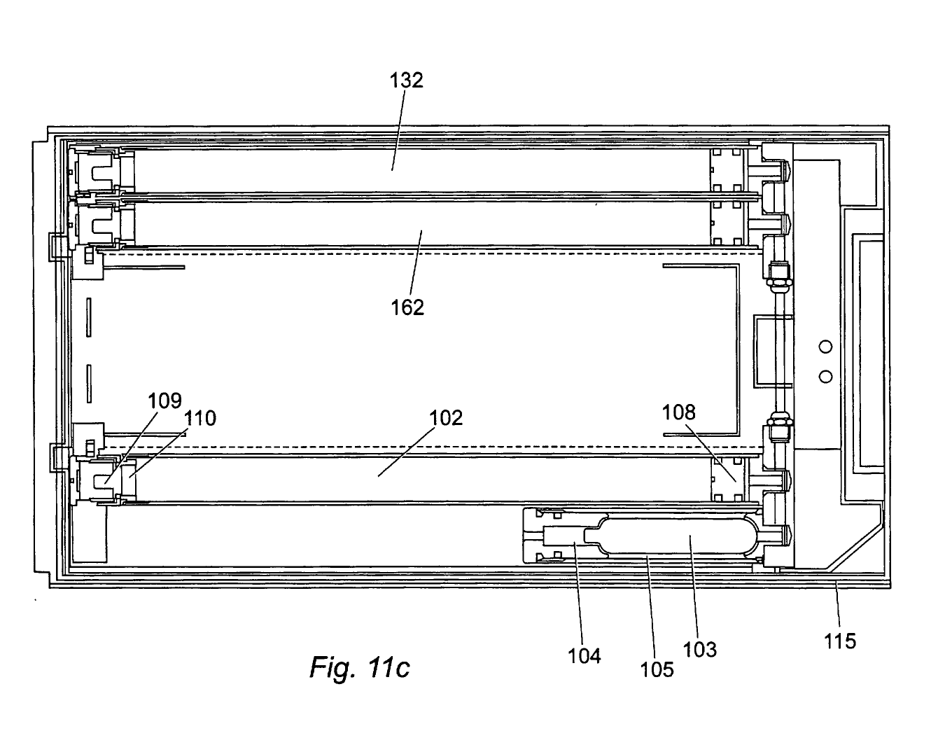

FIG. 11 is a plan view of FIG. 10;

FIG. 11a) shows an actuating protractor with its piston in the unfired position;

FIG. 11b) shows an actuating protractor with its piston in the fired position;

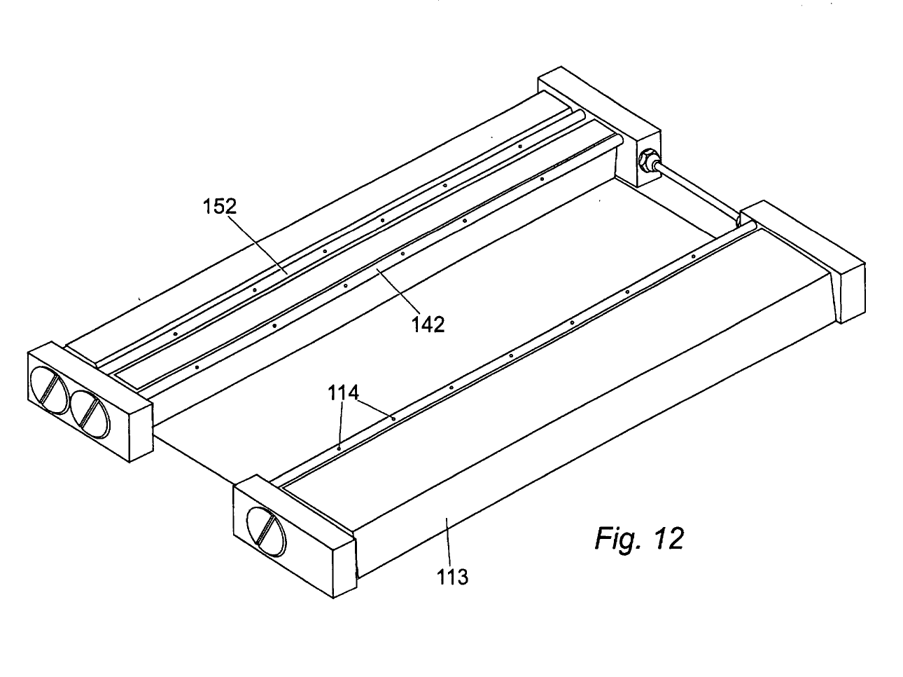

FIG. 12 is a view of FIG. 10 with the trough of an aspect of the present invention in position;

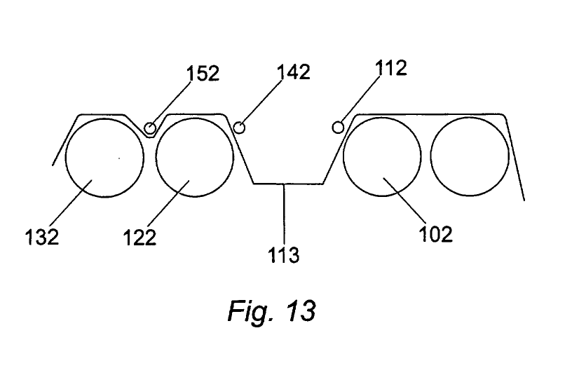

FIG. 13 is a cross section through FIG. 12 showing the position of the trough in relation to other elements of the dye distribution system of an aspect of the present invention;

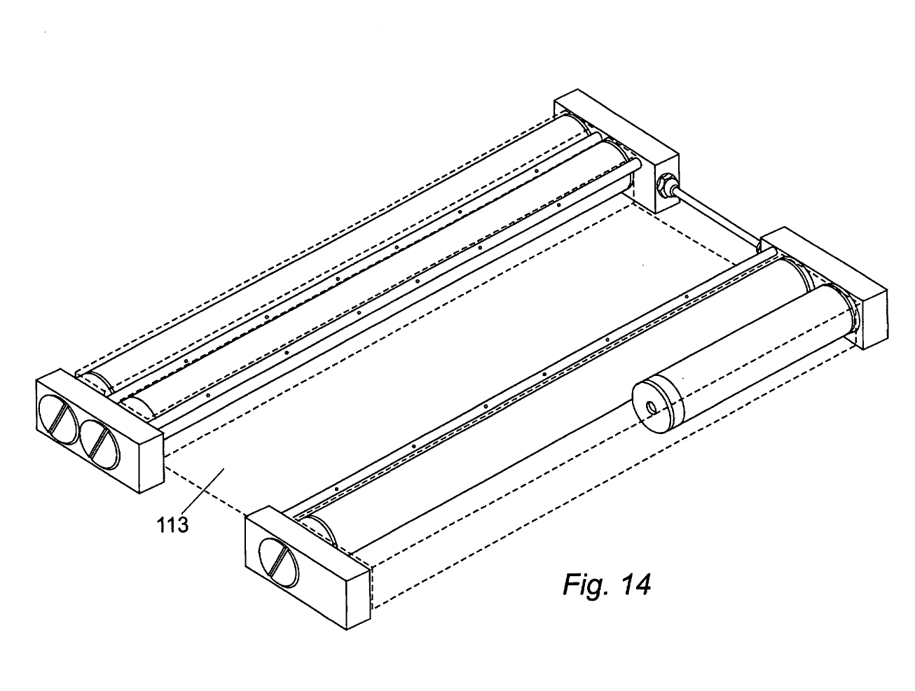

FIG. 14 is a view of FIG. 12 with the trough of an aspect of the present invention shown in dotted outline to illustrate its spatial relationship to other elements of the dye distribution system; and

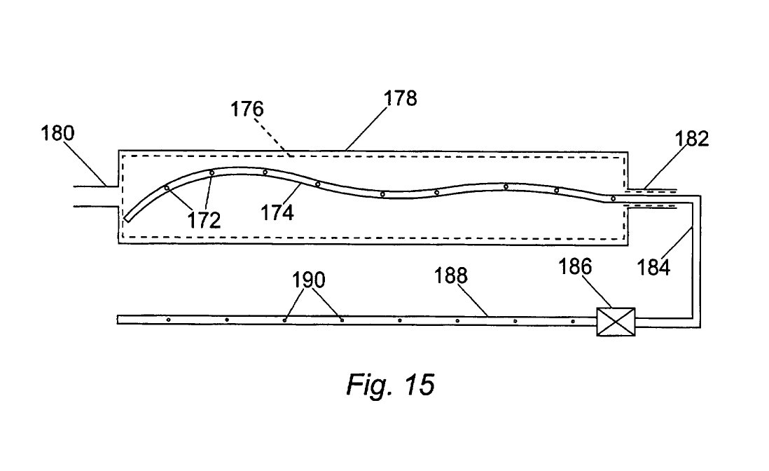

FIG. 15 is a schematic diagram of an implementation of a dye distribution system using a compliant container approach.

Referring to the drawings, a tag system comprises an electronics unit (or ‘tag’) 1 and a reader. The tag 1 comprises three main elements, a receiver, a micro-controller 14 and a transmitter. The receiver is software supported and of low power consumption. The receiver comprises a receive antenna 2 adapted to detect incoming signals and the transmitter comprises a transmitting antenna 20 adapted to transmit data. The tag 1 further comprises a power source, most commonly a battery (not shown).

The micro-controller 14 comprises a decoder, and a data memory 16. The tag 1 further comprises electronic circuitry in the form of a clamp 4; a mixer comprising a local oscillator 8, a switch 10, and a controllable current source 6; a gain controlled amplifier 12; and an RF transmitter 18.

The local oscillator 8 employs a very low power low frequency crystal.

The tag 1 is adapted to be easily mobile. In an alternative embodiment, the tag 1 may be adapted to adopt a fixed position. The tag 1 is adapted for attachment to a moveable article, and is thus of small physical size to facilitate use.

The tag 1 is configured to communicate with control apparatus that sends commands to the tag 1, and/or receives data transmitted by the tag 1. Sending commands to a tag 1 is generally termed a ‘write’ function. Receiving data from a tag 1 is generally termed a ‘read’ function.

The system also comprises control apparatus in the form of a dedicated reader 22. The reader 22 is described in detail below.

The receiver of the tag 1 is permanently ‘awake’. The micro-controller 14 of the tag 1 is normally in stand-by mode, in which it consumes little or no current. When there is a requirement to communicate with the tag 1, a ‘wake-up’ signal is transmitted by the reader 22. This wake-up signal is of low-level, and is received in the antenna 2. When the receiver detects the wake-up signal, it wakes the micro-controller 14.

That is, the initial elements of the circuitry of the tag 1 operate on a very low power supply current, yet are sufficiently sensitive to pick up this low-level wake-up signal, to discriminate between that signal and ambient noise, and to respond rapidly to ‘wake-up’ the micro-controller 14.

In one embodiment of the invention, the wake-up signal is coded. In this embodiment the code is generated in the reader 22, and is normally system specific.

It is necessary for the tag 1 to amplify any incoming signal it picks up, to provide adequate sensitivity of detection. Signal amplification at carrier frequency would demand significant power. However, one aim of the instant invention is to provide a tag having low power consumption and thus minimal battery drain. To fulfil this aim of low power consumption, the circuitry of the tag 1 converts an incoming signal to a low frequency signal prior to its amplification.

That is, to achieve valid data transfer over the distances required for useful system operation, the signal sent by the reader 22 to the tag 1 is converted to low frequency before decoding. Low supply current is an essential characteristic for long term system operation.

Amplification of signals operating at carrier frequency requires supply currents well in excess of what is available from realistically sized batteries with useful operational life. Amplification of a low frequency signal requires significantly less power, which means the power source will have long life. The tag 1 thus includes a mixer that reduces an incoming signal to a frequency at which low supply current amplifiers can provide adequate gain bandwidth.

In use, an incoming signal is received in the antenna 2, and passed through the clamp 4. The clamp 4 limits the signal to set parameters. The output of the clamp 4 activates the current source 6, and controls its current output.

The local oscillator 8 operates continuously to provide a signal of frequency of a fraction of the carrier frequency of the incoming signal. The oscillator 8 drives switch 10.

The mixer mixes the output of the current source 6 and the switch 10. The mixed output of the current source 6 and the switch 10 produces a signal of frequency well below the carrier frequency of the incoming signal. This signal is fed to the gain-controlled amplifier 12.

In this way, the electronics unit 1 converts the incoming signal to a frequency substantially below carrier frequency prior to amplification.

The amplifier 12 then amplifies the signal.

Mixing the signal carrying the incoming data with a low frequency signal has the effect of providing a combined carrier signal of frequency to which the data is no longer synchronised.

For this reason, the tag 1 comprises means to compensate for the unsynchronised data prior to, or whilst decoding the coded signal.

Once amplified by the amplifier 12, the combined signal is fed to the decoder block of the tag 1. Since the data supplied to the decoder block is not synchronised to the frequency of its carrier signal, the decoder block comprises compensation means in the form of the microcontroller 14. The microcontroller 14 acts in conjunction with the data memory 16 to decode the output of the amplifier 12.

The microcontroller 14 employs a unique software-driven correlation technique to process the mixed signal. This technique gives highly robust data extraction with a very high tolerance of ambient noise.

The software comprises a customised mathematical correlation algorithm. This correlation software allows the decoder block to interpret data even although it is no longer synchronised to the frequency of the mixed signal. The operation of decoding and its associated auto-correlation function is described below.

The micro-controller 14 is further adapted to incorporate software which removes common underlying noise from the mixed signal to improve effective signal to noise ratio.

The micro-controller 14 requires appreciable battery power when operating.

The same algorithm is used to decode data both within the reader transmitter and within the tag. After demodulation of the incoming signal:

logic ‘0’ is represented by the transmission of a single cycle within one bit period; and

logic ‘1’ is represented by the transmission of a double cycle within one bit period; as shown in FIG. 4.

It is expected that, because there is no absolute synchronisation of transmitter and receiver clocks, the signal decoded in the electronics unit 1 may show a very low frequency drift in time with respect to the transmitted signal. As a result, application of simple decoding techniques relying on bit start times would produce errors. This problem is overcome in this invention by the use of a unique correlation technique.

For the correlation technique devised for this purpose, the frequency-mixed thresholded waveform (output of gain controlled amplifier 12) is sampled at 16 times the bit rate. The value of each sample (‘0’ or ‘1’) is fed into a 16-bit shift register. The bit emerging from the shift register is compared with the current bit. If they are unequal, a count is incremented. If they are equal a count is decremented. If the two bits match, the count will be zero (unless the relative drift rate between reader clock and electronics unit clock is great in which case it could be 1 or 2. If the two bits are truly different, the count will be 8 (unless the relative drift rate between reader clock and electronics unit clock is great in which case it could be 7 or 6).

That is, no matter the realistic rate of relative clock drift, logic ones and zeros will be unequivocally different irrespective of notional start times.

In practice, data is encoded at the transmitter in order that the correlator gives bit values directly.

Data is sent asynchronously, with one start bit, eight data bits and one stop bit, thus ensuring that the relative clock drift effect is virtually eliminated.

ALGORITHM FOR TRANSMITTED DATA
Send ‘1’ as start bit
Wait 1 bit period
WHILE bits in byte to send

IF bit is a ‘1’

IF previous bit was a ‘1’

send a ‘0’

ELSE

send a ‘1’

ENDIF

ELSE

no change in data sent

ENDIF
wait 1 bit period

ENDWHILE

| | |
|---|---|
| Wait 1 bit period | (start bit always zero, |
| | therefore no data change) |

| Set data to ‘0’ | (ready for next slot bit) |
|---|---|
| ALGORITHM FOR RECEIVED DATA | |
| shift in current bit to 16-bit delay register | |
| IF current bit (t₀) and bit out of delay register | |
| (t₁₆) | different |

increment correlator count

ELSE

decrement correlator count

ENDIF
IF correlator count > 4

decoded bit is ‘0’

ELSE

decoded bit is ‘1’

ENDIF

The output of the micro-controller 14 is fed to the radio frequency transmitter unit 18, and thence to the transmitting antenna 20 for transmission of electronics unit output to a reader. In this specific embodiment the transmitting antenna 20 is a UHF antenna.

It is also possible to have inputs to the tag from sources other than the antenna 2, and to have outputs from the tag via channels other than UHF antenna 24. Such inputs and outputs may be, for example, hard wired optical or acoustic. The program stored in program memory 16 may be changed on the fly.

The tag is programmable and, if required, can be programmed to switch in additional stages of receiver gain for increased sensitivity once it has been wakened to its full operating state. That is, the gain-controlled amplifier 12 is employed to adjust the threshold of detection of incoming signal to S compensate for varying levels of ambient noise. For example, instructions to the gain-controlled amplifier 12 to increase the receiver gain may be sent from the reader 22, or may be generated on the initiative of the tag 1 in response to a given set of circumstances, such as the absence of a signal for a particular period of time.

Importantly, the variable gain amplifier may also be used as means of assessing the distance between reader and tag through exploitation of its controllably variable characteristics, and the highly predictable variation of VLF signal strength with range.

The tag 1 can be configured to operate autonomously or under the control of a reader, once it has been activated by a dedicated reader 22. That is, the tag 1 can be configured to operate autonomously and to control its own behaviour; or the tag 1 can be configured to co-operate with a reader in order to transact data or to have its behaviour adjusted.

In this described embodiment, the reader 22 uses near field very low frequency (VLF) signals to write to the tag 1. The tag 1 is adapted to employ frequency modulation to handle the very wide dynamic range of incoming signals without the necessity for automatic gain control, with the concomitant delay in response to varying signal levels.

When the reader 22 is employed, it is typically the reader 22 that initiates correspondence between tag and reader, for example for data transaction, or to alter the behaviour of the tag 1. A reader 22 can address a tag 1 uniquely, or can address a specified block of tags 1, or can globally address all tags with which it is configured to transact.

Alternatively, a tag 1 can be configured to initiate a transaction.

The wake-up signal is sent from the dedicated reader 22.

The reader 22 comprises a control function block 24 comprising control function means 26, and further comprising display means 28 and/or man/machine interface means 30, as required. That is, the control function block 24 of the reader 22 can be customised depending upon the purpose to which it will be put.

The reader 22 further comprises a code generator 32; a transmitter driving block 34, comprising signal filtering means and power amplification means; and a transmitting antenna 36, driven by the block 34.

The code generator 32 is adapted to encode commands to be transmitted to tags 1. Each code is system unique.

In use, a command to be transmitted to a tag 1 is input in the code generator 32 and a code unique to the particular system is generated.

The coded signal is then filtered and amplified before transmission by the transmitting antenna 36.

The reader 22 can also be adapted to receive data transmitted by a tag 1. For this purpose, the reader 22 comprises a receiving antenna 38, and a receiver 40. The receiving antenna 38 is adapted to collect data transmitted by a tag 1. Detected data is decoded in the receiver 40. The receiver 40 is adapted to interface with the display means 28 and/or man/machine interface means 30 for access by a user.

The reader 22 can be adapted to act intelligently. Additionally or alternatively, the reader 22 can be adapted to operate as an element in a network of readers 22 and/or be controlled by a central processor.

Typically a reader 22 has a fixed position. However, a reader 22 may be adapted to be mobile.

A representation of a typical array comprising a system of tags 1 and readers 22 is shown in FIG. 3. Unlike conventional tag/reader arrangements, this invention provides a system comprising a tag 2 adapted to be awakened on command from a reader 22, at a range of many metres. The transmission range of ‘read’ and ‘write’ data between a tag 1 and a corresponding reader 22 are not necessarily identical. The ‘read’ range is typically, although not necessarily, longer than the ‘write’ range.

FIG. 3 illustrates limits of command range for four separate readers 122, 222, 322, 422 indicated by circles. This example shows that the limits of command range may overlap as with readers 122, 222 & 422, or may be isolated as with reader 322. It can be appreciated that the field of any reader can encompass a limitless number of tags 1. In this example, tag T1, tag T2 and tag T3 may be controlled by reader 122; tag T4 and tag T5 may be controlled by reader 122 or reader 422; tag T6 may be controlled by reader 222 or reader 422; tag T7 may be controlled by reader 422; tag T8 may be controlled by reader 122 or reader 222 or reader 422; and only tag T9 and tag T10 may be controlled by reader 322.

Tag T11 and tag T12 are outwith the control range of all four readers 122, 222 322,422. However, as described above, the ‘read’ range from a tag 1 to a reader 22 is typically longer than the ‘write’ range. Thus, tag T11 and tag T12 can operate autonomously and be capable of communicating with a reader 122, 222, 322, 422 even if the reader 122, 222, 322, 422 is not capable of communicating to the tag T11, T12.

This capacity of the tag 1 to be awakened on reader command is independent of the respective orientation of tag 1 and reader 22. In one embodiment of a tag/reader system this is achieved because the reader 22 is adapted to transmit phased signals from multiple antennae. In an alternative embodiment, the reader 22 comprises a single antenna adapted to transmit phased signals. This has the effect of effectively reducing the attitude sensitivity of the tag 1 with respect to the reader 22 to zero. That is, this system is effectively attitude independent.

In an alternative embodiment of an tag/reader system this capacity of the tag 1 to be awakened on reader command independent of the respective orientation of tag 1 and reader 22 is achieved because the tag 1 incorporates receiving antennae lying along each axis. This again has the effect of effectively reducing the attitude sensitivity of the tag 1 with respect to the reader 22 to zero. That is, this embodiment of the system is also effectively attitude independent.

In known systems, tags are very attitude sensitive and the angle of presentation of tag to reader is critical.

Further, the capacity of the tag 1 to be awakened on reader command is independent of line of sight between tag 1 and reader 22. In known systems, the line of sight between tag and reader must be clear.

That is, this invention comprises a tag and corresponding reader wherein a tag may be activated remotely at significant range without line of sight and regardless of respect of attitude of tag and reader.

A battery powering the tag 1 typically has a life in excess of two years. The tag 1 is at all times capable of immediate detection of a command signal from a reader 22 and adapted to provide an immediate response.

Thus, this system is adapted to operate on command, with zero or near zero standing power consumption, at long range (in excess of twelve metres), regardless of the orientation of the tag 1, and without need for a line of sight between tag 1 and reader 22.

This system has a wake up range of a minimum of seven metres. The typical wake up range is approximately twelve metres, but can be adapted to be greater.

The tag 1 comprises a highly sensitive receiver adapted for high selectivity, which operates on minimal quiescent supply current.

The tag 1 combines low battery power consumption with high receiver circuit sensitivity. The circuitry of the tag 1 operates on very low power supply currents that are nonetheless sufficiently sensitive to detect a low-level wake-up signal, to discriminate between such a signal and ambient noise, and to make a rapid response. That is, the tag 1 is adapted to respond to a random time wake up signal in a fraction of a second.

The tag 1 of the present invention has numerous applications.

Once activated the tag 1 is capable of autonomous behaviour, of interaction with the original or another reader, and of interface with sensors or transducers.

The system comprising the tag and a reader, where the micro-controller 14 ‘wakes’ on command, also has numerous applications. A specific embodiment of a tag 1 in the form of an in-container tag for use relation to, for example, a cash cassette for use in an ATM, is described below.

A further example of a useful application of the tag is the monitoring of assets, such as moveable property, for their protection, for example in the retail sector. The tag alerts a proprietor to the unsanctioned movement of his asset.

Conventional retail ‘electronic surveillance’ employs simple low cost tags (‘tags’) in combination with a reader or readers to detect movement of the asset. An asset is tagged and a reader of limited range is deployed in the exit(s) from the area where the asset is stored. The reader detects movement of the tagged asset through a passage, commonly a doorway, where the reader is deployed. With this surveillance technique the detection passage must be narrow because of the limited range of the reader, and missed or false reads are commonplace. It is a simple matter to move an asset whilst avoiding the protected passage, or to suppress such tags to block their detection by the reader.

It is obvious that a proprietor should like to prevent unauthorised removal of their property through any possible exit including, for example, windows.

In addition, the situation often arises where a proprietor should like to ascertain whether their property is in process of being moved, to check whether their property is in the possession of an authorised person, to conduct periodic checks to ensure their property is located where it should be, or merely to check that its protective tag is fully operational. Conventional tags do not have these capabilities.

The tag 1 of the present invention is adapted to be unequivocally detected on entry to a specified area, and to be read by one or more readers situated across a threshold that may be many metres wide and many metres high. That is, assets may be ‘tagged’ with embodiments of the tag of the present invention.

Although a continuously powered device could be adapted to fulfil this function, the life of any battery associated with such an application would be of the order of hours, unless it was of such size as to render the tag unwieldy and impractical.

The tag 1 of the present invention is normally in a quiescent state in which it requires negligible power until commanded to waken by a dedicated reader or by some stimulus which the tag 1 detects autonomously, at which time all necessary data operations and transactions can take place.

While ‘assets’ or ‘property’ are generally considered to be items of hardware, protection of babies in maternity hospitals and pupils in schools are just two more examples of many ‘asset protection’ systems presenting similar sets of problems which the apparatus of the instant invention serves to solve.

The invention has further application in several types of logistics operations; for example where there is a requirement to know the entire manifest of a goods transport vehicle, either in terms of the packages or pallets which comprise its load, or in terms of the contents of individual pallets.

In many cases it is also desirable to accumulate information on occurrences during a journey, for example of instances of door openings, or of temperature excursions, and to download such information on arrival at a particular depot.

In this example, any entrance through which the vehicle must enter a depot must be both wide and high, thus necessitating a tag/reader system of long range, and the likely time of a journey militates against a ‘continuously awake’ device. The long-range wake up facility of the tag of the instant invention facilitates its use in a tag/reader system for this purpose, since it allows the tag 1 to remain effectively dormant until explicitly woken by reader command.

The tag 1 has further application in motor vehicle systems. That is, there are many opportunities for use of embodiments of the tag 1 in cars in all developed countries in the world. Road pricing or tolling is one obvious application. A further example is where there is a need for interrogation of vehicle records by a mobile or pedestrian patrol to check on validity of all the vehicles in a street, such as with resident parking in cities. Deployment of an embodiment of tag 1 in each vehicle allows that this be done without either approaching each vehicle or in turn or (importantly in certain cases) being seen to inspect a vehicle.

The principle of the system is readily extendible into an ‘electronic vehicle document’. This offers great versatility, ease of automatic checking for validity or theft, capability for discretionary charging dependent on use, area of use or highways used.

The instant invention has sufficient battery life and response technology for this application.

Although, in principle, there is plenty of electrical power available in a road going vehicle, a self-powered tag 1 removes the problem of installation.

Furthermore, the need for a fast response to the transient presence of reader demands that the tag 1 is adapted to be activated rapidly and thus be awake when a transaction is required.

In a further application the tag 1 of the instant invention can be activated within a zone or ‘portal’ of unrestricted width. That is, the apparatus of the present invention can implement portals of any width and, for most practical purposes, of any height.

In conventional access control systems, portals are effected by windings on either side of an opening of maximum width and height of around two metres. Installation of such access control systems demands substantial modification of door frames, often with concomitant disruption of flooring to install part of a winding below ground level.

The instant invention provides a portal comprising a reader in the form of, for example, a free-standing unit at either side of a twenty metre opening, or a cord at a height of the order of ten metres carrying as many antennae as necessary to cover a gap of given (but effectively indefinite) width. This gives a portal of any width and a height of many metres.

Some further applications for the tag 1/reader 22 apparatus include: access control for upper levels of buildings; intelligent buildings; secure remote control; animal passports and livestock management; intelligent lot travellers; separation alarms; asset protection; inventory management; toll roads and bridges; cargo management; local announcements; traffic informatics; cash in transit; object location (both static and mobile); visitor/traveller control; industrial safety; personnel location and communication; and wireless data gateways.

A specific application is now described.

There is constant movement of banknotes from banks to cash handling centres, to stores and to ATMs. For a variety of operational reasons, substantial amounts of cash are also retrieved from the ATM for return to the cash-handling centre or bank. In some embodiments of ATM the cash for distribution is housed in a cassette. In this embodiment, cash is loaded into the cassette at a cash-handling centre, delivered to the machine, and installed intact. The cassette is later retrieved from the ATM for return to the cash-handling centre.

The cycle of delivery of bank notes to, storage of bank notes in, and the removal of bank notes from ATM sites is perceived as an opportunity for theft. The most vulnerable point of the cycle is probably transport of the notes between a delivery vehicle and the ATM site—commonly termed ‘crossing the pavement’. However cash is vulnerable to attempted theft at any time during the cycle from cash handling centre to ATM and back—at the cash handling centre where the bank notes are loaded into cassettes, en route to and from an ATM, at the ATM site, or from the ATM itself, for example by means of ram raid or other form of attack.

The safety of both bank staff and cash in transit. given time frame. The smoke-dye system has the intended purpose of attracting attention, and staining and thus destroying the cash.

Mechanical locks are expensive, and smoke dye is not particularly effective at staining banknotes. Pyrotechnic cartridges have the further disadvantage that smoke dye released by an activated cartridge damages any goods in the vicinity. This is particularly inconvenient when the cartridge is activated on shop premises. In addition the smoke-dye system is prone to false trigger, with concomitant wastage of stock.

A cassette for the transport and storage of cash for use in ATMs is designed to be loaded with banknotes in a cash-handling centre or bank, and then distributed to the site of an ATM by vehicle. The loaded cassette is configured for installation intact in the ATM. The cassette comprises protection apparatus comprising a tag 1 and associated remote control apparatus 22, configured as an in-cassette electronics unit (ICE) and apparatus adapted to deposit liquid dye from a dyepack directly onto the banknotes.

The ICE 50 and the dye deposit apparatus are housed within the cassette without limiting its capacity for cash. In one embodiment of the invention, the protection apparatus further comprises the cassette itself.

The protection apparatus protects cash loaded in a cassette from the instant the cassette is loaded throughout the cycle until it is returned to the cash-handling centre. If the cassette becomes jammed in use, or is only partially emptied, the apparatus also provides protection on the return trip to the cash-handling centre. The ICE 50 is designed to require elapse of a pre-programmed time delay, or to check for authorisation before permitting access to the cassette, to delay authorised access, so that a prospective thief is detained, and to destroy the contents of the cassette in the event that unauthorised access is attempted or achieved. Indication that the cassettes of an ATM are so protected, for example on the ATM screen or on the side of a transport vehicle, provides a substantial deterrent to attack.

FIG. 8 shows a typical cycle of movement of cash in transit, from a cash handling centre, through the various stages of transit and banking operations, and back to the cash-handling centre.

The protection apparatus comprises intelligent electronics, which operate substantially as described above in the specific embodiment of an In-Cassette Electronics (ICE) unit 50 as shown in FIG. 5. The ICE unit 50 comprises an antenna 51, a transmit/receive unit 52, a decode stage 53, sensors and transducers 54, a microprocessor 55, an acquired data store 56, a dye pack activation unit 57, and an autonomously, for example to initiate dye pack activation should circumstances dictate.

Data commands to the ICE unit are picked up in antenna 51. The data is decoded by the combined activities of the transmit/receive unit 52, the decode stage 53 and the microprocessor 55. The microprocessor 55 also contains the operational programmed for the apparatus, and pre-programmed information on time out values, cycle sequences etc. The microprocessor 55 acquires information from the sensors and transducers 54, and acts on the pre-programmed information and the information acquired from the sensors and transducers 54 to store a history of events in the acquired data store 56; to make decisions on arming status; to trigger the activation unit 57 to activate a dye pack to deposit liquid dye directly onto banknotes; or to provide communication as required.

The ICE unit 50 is configured to transmit data back to the readers, providing information such as feedback on its own functionality, status or audit trail information.

Crucially, the ability of the ICE unit 50 to transmit data back to the readers allows the protection apparatus to control access to a cassette without the use of mechanical locks. That is, the ICE unit 50 obviates the need for physical prevention of access such as mechanical locks, since unauthorised access has the penalty of destruction of the useful purpose of the contents of the cassette.

Where there is data to be communicated from the ICE unit 50, the microprocessor 55 drives encode stage 58 which in turn drives the transmit stages of the transmit/receive unit 52. Output is then transmitted from antenna 51. In a further embodiment, the antenna 51 is distinct from the ICE unit 50.

In receive mode, when receiving data from the ICE unit 50, signals are picked up by the control transmitter in antenna 63, received and decoded by the combined activities of the transmit/receive unit 62, decode stage 64 and micro-controller 59. The micro-controller 59 then performs further processing of the data, and distributes it as required.

The ICE unit 50 comprises a receiver 62 and receives signals from one or more control transmitters 70, as shown in FIG. 9. The control transmitters 70 are write/read units as shown in FIG. 2, generally referred to as ‘readers’.

The ICE unit 50 is not normally ‘armed’. The ICE unit 50 is armed when cash is loaded in the cassette. Once armed, recognition by the ICE unit 50 of the presence or absence of signals from these control transmitters establishes that it is in, or in transit between ‘areas of safety’. That is, information exchange between the ICE unit 50 and control transmitters 70 allows each cassette to know where it is, where it has to be next and when it has to be there.

This knowledge is allied to the ability of the ICE unit 50 to accept direct commands from the control transmitters 70, such as, START TIMEOUT, END TIMEOUT or ACIVATE DYEPACK.

For example, the ICE unit 50 is conditioned to trigger the apparatus if an attempt is made to breach the cassette—that is; the dyepack is activated if the cassette lid is opened without the ICE unit 50 first having been disarmed.

The ICE unit 50 is conditioned to trigger the system when it ‘times out’ between areas of safety, that is when an expected interval between received signals, programmed or pre-programmed in the microprocessor 55 is exceeded.

A typical operational sequence of a protection apparatus is shown below in tabular form

| | | Dyepack triggered |
|---|---|---|
| Action | Function/Command | on: |
| Close Lid | Arm cassette | Lid open |
| | | Shutter tamper |
| Load cassette on | None | Lid open |
| truck | | Shutter tamper |
| Exit through truck | ICE initiates time | Lid open |
| hatch | out (Tₛ₎ | Shutter tamper |
| | | Expiry of Tₛ |
| Reach ATM | None | Lid open |
| | | Shutter tamper |
| | | Expiry of Tₛ |
| Open ATM door | ‘ATM Open’ signal | Lid open before |
| | transmitted from | expiry of delay |
| | ATM door antenna. | time (Tₒ₎ |
| | Receipt of signal | |
| | by ICE ends T_{s,} and | Direct command (on |
| | permits shutter | receipt by the ATM |
| | opening | Transmitter of a |
| | | validated alarm |
| | | signal) |
| Close ATM door | ‘ATM Closed’ | Lid open |
| | signal | |
| | transmitted. | Direct command (on |
| | | receipt by the ATM |
| | ICE goes into | Transmitter of a |
| | armed sleep mode, | validated alarm |
| | waking every few | signal) |
| | seconds to check | |
| | that ‘ATM Closed’ | ‘ATM Closed’ |
| | signal is still | signal not |
| | being received | received AND |
| | | cassette moved |
| | | (this feature |
| | | allows for loss of |
| | | signal within in |
| | | ATM due to a |
| | | system failure; |
| | | loss of signal |
| | | coupled to |
| | | movement is a |
| | | statement of |
| | | illegal action) |
| Open ATM door | ‘ATM Open’ signal | Lid open before |
| | transmitted. ICE | expiry of delay |
| | registers receipt | time (Tₒ₎ |
| | of signal. | |
| | Initiate delay | Direct command (on |
| | time (Tₒ₎ | receipt by the ATM |
| | | Transmitter of a |
| | | validated alarm |
| | | signal) |
| Remove cassette | ICE initiates Tₛ | Lid open |
| from vicinity of | | |
| ATM | | Shutter tamper |
| | | Expiry of Tₛ |
| Enter through | ICE ends Tₛ | Lid open |
| truck hatch | | |
| | | Shutter tamper |
| Return to ATM | Disarm on Disarm | All protection |
| centre | Cradle | ends |

When the cassette is loaded in an ATM, the ICE unit 50 is programmed to activate the dyepack on activation of a validated alarm within the ATM. That is, if there is an attempt to breach or to steal the ATM, this also triggers destruction of bank notes in individual cassettes.

The ICE unit 50 can also be conditioned to operate a wake/sleep cycle as described above when the cassette is loaded in the ATM, in which it wakes periodically to check for a signal from a control transmitter which, in normal circumstances, is present. If the ICE unit 50 does not receive the expected signal, it can be programmed to take into account the possibility that there may be a benign reason for its absence. The ICE can be programmed so that when it registers disappearance of the signal it is put into a secondary armed state. The ICE includes a movement detector that triggers the dyepack if it registers disturbance of the cassette when the ICE is in the secondary armed state. That is, if there is an attempt to remove the cassette from the ATM, or an attempt to remove the ATM itself when the ICE is in its secondary armed state, the dyepack is triggered.

In operation, in transmit mode, when transmitting commands to the ICE unit 50, transmit commands are developed and combined with data from external inputs in the microcontroller 59. These transmit commands are encoded in the encode stage 61 and transmitted via the transmit unit 62 and its antenna 63.

FIG. 9 demonstrates an example of a number of installed read/write control transmitters influencing the operation of the ICE unit 50, and the sequence in which their influence is exerted on the outward and homeward journeys of the cycle.

This example of the operational system includes the disarm cradle in the cash-handling centre, together with additional installed transmitters in the transport vehicle, at the ATM site, and in the ATM itself, to refresh information as a cassette describes its route.

These can be supplemented by read/write control transmitters comprising the same elements provided as hand held units. Typical uses of these transmitters are for purposes of interrogation or system check of the ICE unit 50 as to its status and functionality at any point in the cycle.

The apparatus optionally includes write only transmitters 80 as shown in FIG. 7, comprising a micro-controller 85; encode stage 86; transmit unit 87; and antenna 88; adapted only to send data to an ICE unit 50. Typically, these write only transmitters 80 are deployed at ‘refresh points’ to refresh ‘time out’ information on long walk routes between a vehicle and an ATM, or within vehicles to send commands to all ICEs within the vehicle to provide location data or activation commands. They may also be used to start and end ‘time out’ periods as cassettes enter and leave the vehicle.

The protection apparatus thus provides protection from tamper at all points in the cycle. Cassettes can thus be transported in a non-armoured vehicle.

When access to the interior of a cassette is necessary during the cycle, control of such access by authorised personnel is operated on a visit/machine/cassette specific basis, using a multipart code.

A sample procedure is as follows:

1. A technician with authorisation for access is given an Entry Code Word by a controlling operator, typically at a remote site.

2. On arrival at the ATM, the technician opens the ATM using the standard control procedures for that site, and enters the specific Entry Code Word into a hand held interrogator.

3. The interrogator then reads a Response Code Word back from the ICE unit in the cassette.

4. The correct communication from the technician to control verifies that he is the authorised technician with the correct access privilege to this specific ATM at this specific instant. On such confirmation he is informed of an Open Command Word (by speech or other communication medium)

5. The technician then enters the Open Command Word into the interrogator. The ICE unit is programmed to permit removal of cassette lid on entry of the second code to the interrogator, provided the cassette is within the immediate vicinity of the ATM. The Open Command Word is time limited in order that a new Open Command Word is required for each visit. Preferably, a different Open Command Word may be required for each cassette. Exposure of ATM content is thus limited to one cassette at a time.

As shown in the Table above, a pre-set time (Tₒ), which must elapse between the ICE unit receiving the Open Command Word and it being possible for the technician to open the lid without activating the dye pack, is programmed into the ICE unit. This is a significant safety feature in that it helps to safeguard both the ATM contents, and the personal safety of operational personnel in the event of duress in an on site attack. That is, a prospective thief acting at this juncture is considerably delayed if he wishes to access the contents of the cassette in a usable state.

Additionally, the generation of a new Open Command Word can be programmed to be subject to time delay to further enhance the protection of both ATM contents and personnel.

6. On closure of the cassette lid, the ICE unit reverts to its armed state.

If the dye pack is activated, the liquid dye distribution system distributes an indelible dye over the bank notes to stain and make them valueless. It is possible for all dye packs in an individual ATM or on a specific site to be activated simultaneously if there is a validated alarm.

The liquid dye distribution apparatus is now described in detail by reference to FIGS. 10 to 15.

The apparatus comprises a cylinder 102 adapted to contain dye, associated with a pressurising device comprising a carbon dioxide cartridge 103 situated adjacent a protractor 104. The cartridge 103 and protractor 104 are housed within a container 105. The protractor 104 incorporates a piston 106. The piston 106 is moveable between a first retracted position and a second projecting position. A pressure transfer block 107 connects the pressurising device to a piston 108 at a first end of the dye cylinder 102 and via a connecting pipe to pressure transfer block 117 and on to cylinders 132 and 162, The dye cylinder 102 has an outlet 109 at its second end that is normally occluded by a spring drive poppet valve 110. A dye transfer block 111 connects the cylinder 102 to a spray bar 112. The spray bar 112 is situated adjacent a dye collection trough 113. The spray bar 112 has a series of spaced holes 114 therein. The trough 113 is a plastic sheet. The trough 113 sits adjacent the article to be marked.

When the system is primed, the cylinder 102 is filled with dye. When the system is activated the protractor 104 receives an electrical pulse. This operates the protractor 104 and the piston 106 is moved between its first retracted position and the second projecting position thereby piercing the carbon dioxide cartridge 103.

Pressure from the activated carbon dioxide cartridge 103 is transferred via the pressure transfer block 107 to the piston 108 at the first end of the dye cylinder 102.

This pressure drives the piston 109 to pressurise the contents of cylinder 110 to cause the valve 110 to open in turn and to force the contents of the cylinder 102 through the outlet 109, through the transfer block 111, and along the length of the spray bar 112.

The dye is forced out through the holes 114, and into the trough 113. It is important to ensure that there is uniform distribution of the dye over the article surface. The trough 113 or a system of troughs channel the dye to the required target, and ensure an even spread. If the trough 113 were not present, the spray bar 112 would give only patchy distribution of the dye over parts of the article.

Whilst practical and convenient to machine, a cylinder is not necessarily the most volume efficient use of the space available.

A second embodiment of this system replaces the dye cylinder 102 with a compliant (‘squeezy’) container or bag. This arrangement is shown diagrammatically in FIG. 15. This bag 176 is accommodated within a rigid tank 178 that may be of any shape depending on the space in which it is required to fit. The bag 176 is a reservoir for dye. The bag 176 is in communication with a spray bar 188 via a central tube 174 in the bag and on to feed pipe 194 and valve 186. When the system is activated, pressure from the carbon dioxide cartridge (not shown in this diagram but similar to element 103 in FIG. 10) is fed into the interior of the rigid tank. Dye is forced through the dip tube 174, out via the outlet port 182 into connecting pipe 184. The dip tube 174 provides that dye is ejected from the compliant container 176 regardless of the orientation of the tank. Holes 172 in the dip tube 176 prevent any pinching off (or ‘waisting’) of the compliant bag, so that all dye is ejected with no pockets of dye trapped within the compliant container. Valve 186 prevents passage of dye into spray bar 188 under normal circumstances, but opens automatically to release dye when system is activated. Valve 186 may be sited downstream from port 182 or incorporated into the port. In one embodiment the bag is connected directly to the feed from the carbon dioxide cartridge. The bag is normally in deflated state, surrounded by the dye which is housed in the outer rigid container. When the bag is inflated, dye is displaced by the inflated bag, and driven out of the rigid container via the valve to the spray bars. This pressure compresses the bag, opening a valve therein and forcing the dye along the spray bar. The central tube ensures that dye flows freely out of the bag, even if a portion of the bag is constricted for any reason. The trough system as described above spreads the dye and distributes it to points where it penetrates the article most effectively.

The note space is not compromised to accommodate the protection system.

In addition, the protection system is suitable for retrofit to existing cassettes.

The ICE unit is armed throughout the time the cassette is in transit to or from the ATM, and whilst the cassette is installed in the ATM, and is only disarmed in the disarm cradle on return to the cash-handling centre.

The instant apparatus is thus designed to be incorporated within an existing cassette.

The protection apparatus is tailored to fit in the lid 115 of an existing cassette. When fitting the system it is necessary to leave a space 120 in the middle of the lid 115 to accommodate the established system of note distribution from the cassette. This space in the middle of the lid is required to permit longitudinal movement of a protruding tongue that travels substantially the length of the cassette as notes are dispensed therefrom.

This particular system as described in FIGS. 10 to 14 is housed entirely in the lid 115 and thus does not encroach upon the note space in the body of the cassette. If required the system is adaptable for fitment elsewhere within the cassette.

The system comprises three dye cylinders 102, 162, 132, a pair of which 162, 132 run longitudinally at one side of the space 120 in the lid 115, and the other 102 of which runs longitudinally at the other side of the space 120. The container 105 containing the pressurising device is accommodated adjacent the single dye cylinder 102. A single pressurising device operates all three cylinders 102, 162, 132. Coupled pressure transfer blocks 107, 117 connect the pressurising device to the three cylinders 102, 162, 132. Each dye cylinder 102, 162, 132 has an associated spray bar 112, 142, 152. Dye transfer blocks 111, 121 connect each cylinder 102, 162, 132 to its associated spray bar 112, 142, 152. The spray bars 112, 142, 152 are situated adjacent the dye collection trough 113. The trough 113 is a plastic sheet. The trough 113 is threaded between the cylinders 102, 162, 132 and the spray bars 112, 142, 152, and is attachable to the sides of the lid 115. The spray bars retain the trough in the required position. When the lid 115 is on the cassette and the system is quiescent, the sheet 113 is in contact with the edges of notes loaded in the cassette, and acts merely as a backing surface for the notes.

When the system is activated the effect of the trough 113 is to channel the dye and ensure its spread to the points where it will penetrate the notes most effectively. The presence and shape of the trough 113 ensures that the system delivers the dye to the surfaces of the notes independent of the attitude of the cassette. That is, the cassette does not have to be horizontal for the system to be effective. This means that the system is of equal use when the cassette is in transit or installed in an ATM. The troughs 113 ensure even distribution of dye over the surface of each bank note, thus rendering it unusable. That is, the spread of dye on the note is such that the note itself is effectively destroyed. An alternative embodiment of the trough 113 is a sectioned system wherein each hole of the spray bar 112 opens into a separate trough. In this embodiment the trough is hinged and as the cassette gradually empties as cash is dispensed the trough folds over, thus occluding holes of the spray bar 112 opposite empty space. This ensures that, when the system is activated dye is only directed at the remaining notes, and not at the space where notes used to be.

Modifications and improvements may be made to the above without departing from the scope of the invention.

1. An electronics unit for a tag adapted to detect a signal and to be activated by remote means.

2. An electronics unit as claimed in claim 1 comprising means to alter the carrier frequency of the detected signal.

3. An electronics unit as claimed in claim 2 wherein said means to alter the carrier frequency of a detected signal comprises an oscillator adapted to provide a signal of frequency substantially different from the carrier frequency.

4. An electronics unit as claimed in claim 2 or claim 3 comprising software adapted to interpret data from a signal of altered carrier frequency.

5. A tag system comprising a remotely activated electronics unit as claimed in any of claims 1 to 4; and control means.

6. A tag system as claimed in claim 5 wherein said electronics unit and said control means are configured to co-operate regardless of their relative orientation and/or without line of sight.

7. A dye distribution system comprising a dye reservoir and a compliant vessel.

8. A dye distribution system as claimed in claim 7 wherein said compliant vessel is said dye reservoir.

9. A dye distribution system as claimed in claim 7 wherein said compliant vessel is adapted to expel dye from said dye reservoir.

10. A dye distribution system comprising a trough or troughs configured to distribute dye delivered under pressure thereto.

11. Means for protection of cash comprising a container; a tag or tag system in accordance with any of claims 1 to 7; and/or a dye distribution system according to any of claims 8 to 10.

12. Means for protection of cash as claimed in claim 11 wherein said tag is adapted to control access to the container.

13. Means for protection of cash as claimed in claim 11 or claim 12 wherein said tag is adapted to control and/or delay access to the container.

14. Means for protection of cash as claimed in any of claims 11 to 13 wherein said tag is conditioned to initiate said dye distribution system.

15. Means for protection of cash as claimed in claim 14 wherein said tag is conditioned to trigger the dye distribution system when it recognises that the container is not in or in transit between ‘areas of safety’ as defined by the control means.

16. A method of electronic protection or ‘tagging’ comprising the steps of:
placing an electronics unit in physical relationship with an article;
activating or ‘waking’ said electronics unit by means of a signal from a reader at a remote location: and
communicating data to or obtaining data from said electronics unit.

17. A method as claimed in claim 16 further including the step of encoding data prior to communicating said data to said electronics unit.

18. A method as claimed in claim 16 or claim 17 further including the step of decoding data in said electronics unit and/or in said control means.

19. A method as claimed in any of claims 16 to 18 comprising the steps of:
sending an encoded data signal to the electronics unit;
converting the signal to a low frequency signal;
compensating for unsynchronised data;
amplifying the low frequency signal;
decoding the signal by means of a transmit/receive unit; a decode stage; and a microprocessor; and
transmitting information from the electronics unit.

20. A method as claimed in any of claims 16 to 19 comprising the step of compensating for drift in time between the decoded signal and the transmitted signal.

21. Means for protection of cash comprising a container; and a dye distribution system according to any of claims 8 to 10.

22. Means for protection of cash comprising a container; a dye distribution system according to any of claims 8 to 10; and a tag or tag system in accordance with any of claims 1 to 7.

23. Means for protection of cash as claimed in claim 22 wherein said tag is adapted to control access to the container.

24. Means for protection of cash as claimed in any of claims 21 to claim 23 wherein said tag is adapted to control and/or delay access to the container.

25. Means for protection of cash as claimed in any of claims 21 to 24 wherein said tag is conditioned to initiate said dye distribution system.

26. Means for protection of cash as claimed in claim 25 wherein said tag is conditioned to trigger the dye distribution system when it recognises that the container is not in or in transit between ‘areas of safety’ as defined by the control mean.
